(19) United States
(12) Patent Application Publication
(10) Pub. No.: US 2008/0091856 A1
(43) Pub. Date: Apr. 17, 2008

(54) USB provisioning device

(76) Inventor: James Blaisdell, Novato, CA (US)

Correspondence Address: BEYER WEAVER LLP, P.O. BOX 70250, OAKLAND, CA, 94612-0250, US

(21) Appl. No.: 11/549,115

(22) Filed: Oct. 12, 2006

(51) Int. Cl. G06F 13/42

(52) U.S. Cl. 710/63

(57) ABSTRACT

The present invention teaches a variety of methods and systems for utilizing a USB provisioning device to provision a new device. One aspect teaches receiving control of a new device coupled to a USB provisioning device and connecting the USB provisioning device through a network connection to a server. Then the USB provisioning device automatically provisions the new device responsive to information related to the device and information related to the server and relinquishes control of the new device. A USB provisioning device according to another aspect includes an instant messaging client, a provisioning script, and an identifier of the USB provisioning device.

### BACKGROUND

When a network is first implemented, all devices involved may be assigned logical (consistent) addresses, categorized in understandable ways, and associated cables and connecting equipment may be very well organized. Similarly, when an organization first needs a device configured for use, a well-defined set of software may be included in the device configuration. However, over time, this tends to change.

Devices move to different ports on a router, for example. Associated closets for cables, routers and servers become homes to spaghetti-like masses of cables. Consultants are called in to determine what is in a server room and where everything goes. Total cost of ownership for a device and network can ramp up significantly over time.

Similarly, software configurations change and drift over time. Some devices are upgraded properly, others are not. New devices include software not considered for original devices, and newer devices are configured without seemingly obsolete (but still used) software in other instances. Keeping track of this can be an amazing headache. Similarly to networks, total cost of ownership for an inventory of computers of various ages can rise rapidly.

Thus, it may be useful to provide a device which can help with these tasks. A device may, for example, provide capabilities related to conforming settings on a new or reassigned device to an associated network. Similarly, a device may, for example, provide capabilities related to verifying, installing, and updating a configuration of a connected device.

### BRIEF DESCRIPTION OF THE DRAWINGS

The present invention is illustrated by way of example in the accompanying drawings. The drawings should be understood as illustrative rather than limiting.

FIG. 1 illustrates an embodiment of a system for use as a USB provisioning device.

FIG. 2 illustrates an embodiment of a wired network in which a USB provisioning device may be used.

FIG. 3 illustrates an embodiment of a wireless network in which a USB provisioning device may be used.

FIG. 4 illustrates an embodiment of a process of operating a USB provisioning device.

FIG. 5 illustrates an embodiment of a system in which a USB provisioning device is in use.

FIG. 6 illustrates an embodiment of a process of using a USB provisioning device on an ongoing basis.

FIG. 7 illustrates another embodiment of a network in which a USB provisioning device may be used.

FIG. 8 illustrates an embodiment of a device which may be used with a USB provisioning device.

### DETAILED DESCRIPTION

A system, method and apparatus is provided for a USB provisioning device. The specific embodiments described in this document represent examples or embodiments of the present invention, and are illustrative in nature rather than restrictive. Provisioning devices for use on a network, or by a group of users can involve a great deal of effort. Network addresses must be set correctly, physical addresses properly recorded and provided to a network, and configuration images must be properly constructed. This can be a process which changes over time and for which decisions are made remotely relative to the actual provisioning process. Thus, one involved in provisioning a device may have multiple opportunities to make mistakes or otherwise experience problems due to lack of automation.

Much of this may be remedied by providing an automated or interactive provisioning device. As most devices currently allow for use with USB connected devices, using a USB connection may be similarly useful for a provisioning device. Such a device may then be used with a variety of devices to be provisioned for use with a network or in a locale, for example. Moreover, such a device may be relatively small and portable, allowing a user to easily transport the device to various different devices of varying sizes (e.g. printers or laptops, for example). Having such a device available may allow for reduced labor costs and more uniform provisioning, potentially reducing total cost of ownership for devices.

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Features and aspects of various embodiments may be integrated into other embodiments, and embodiments illustrated in this document may be implemented without all of the features or aspects illustrated or described.

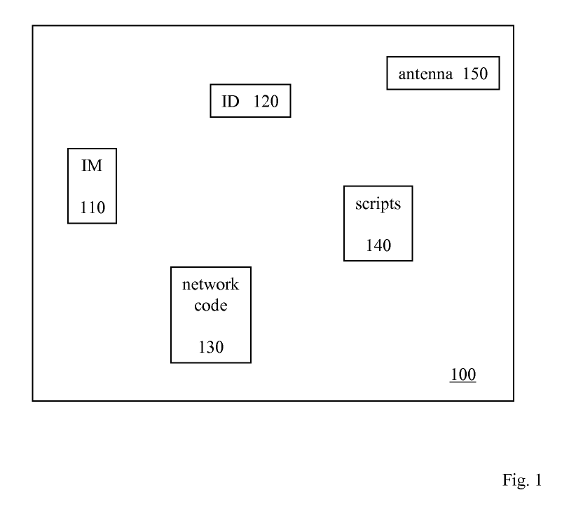

FIG. 1 illustrates an embodiment of a system for use as a USB provisioning device. Device 100 includes an instant messaging or similar communications module, an identification module, a set of scripts, network code, and an antenna. Some embodiments may not include the antenna, or other components, depending on design choices. Device 100 thus may provide a communications path of its own or may use existing communications paths.

Device 100 includes a local identifier 120, which may be a digitally signed identifier, for example. Such an identifier may be used to authenticate the provisioning device in its interactions either with a device to be provisioned or with a network or other installation in which provisioning occurs. In one embodiment, instant messaging module 110 is used to communicate, using peer-to-peer or similar instant messaging protocols. This allows for use of a simple and well-established protocol for communication of data related to provisioning of components and devices. An instant message may be sent to a designated address with information about a device, and a confirming message may be sent back to verify the message was received.

Note that various communications algorithms and protocols may be used. For example, an HTTP or SSH protocol may be selected. Similarly, different options for logging in and/or authenticating a provisioning device, a device to be provisioned, or a user, for example. Thus, a username and password may be used, and may be provided for single use or for reuse execution. Alternatively, a certificate may be used for authentication. Likewise, an autologout option may be used to handle situations where a disruption in network connectivity occurs. Moreover, using instant messaging can involve using an IRC channel, for example, and may involve different chat rooms for different purposes, allowing a user to monitor automated signal traffic or review logs of such traffic, for example.

Scripts 140 may be run to provision various different devices or types of devices. For example, a first script may be run to determine what is being provisioned. Based on results of this, a script may be selected from the set of scripts to execute the provisioning process for the device in question. Different scripts may be used for different devices, such as computers, cellular telephones, personal digital assistants, personal media players (e.g. iPods available from Apple Computer for example), other personal devices, printers, other peripherals, and other components that communicate with a network. Network code 130 may include codes used to authenticate devices or provision devices for a specific network, for example. Alternatively, network code 130 may include specific code modules for a given network, for example. Antenna 150 may be used for wireless communications, either in a wireless network, or in a wired network with an available wireless channel.

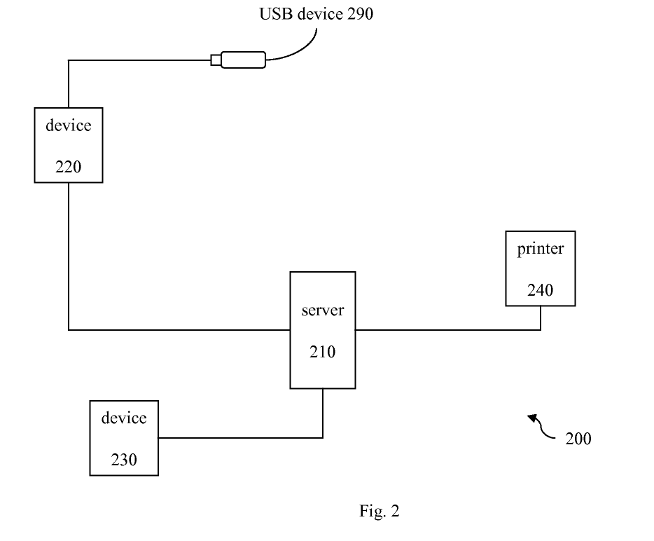

Various different networks, for example, may be involved in specific provisioning. FIG. 2 illustrates an embodiment of a wired network in which a USB provisioning device may be used. Network 200 provides an environment in which devices may be provisioned. Server 210 is coupled through wired connections to device 220, device 230 and printer 240. As illustrated, USB provisioning device is coupled to device 220, such as through a direct USB connection or through a cabled USB connection, for example.

Thus, USB provisioning device 290 may communicate with server 210 to provision device 220, either through the wired network connection of device 220 or through a wireless network connection if available to the provisioning device 290. Device 220 may be a desktop or laptop computer for example. Alternatively, device 220 may be any number of different types of personal devices, such as a cellular telephone, personal digital assistant, two-way pager, or other personal device, for example. Likewise, device 220 may be a different type of networked component, such as a scanner, document processing station, kiosk, or other device, for example.

Similarly, device 230 may be any number of different devices within the network. Such devices may be provisioned to allow for proper network communication, with protocols initialized, network addresses set, and similar data provided. Similarly, provisioning may include communicating physical addresses for a device, and otherwise providing to a server preset information about a device, for example.

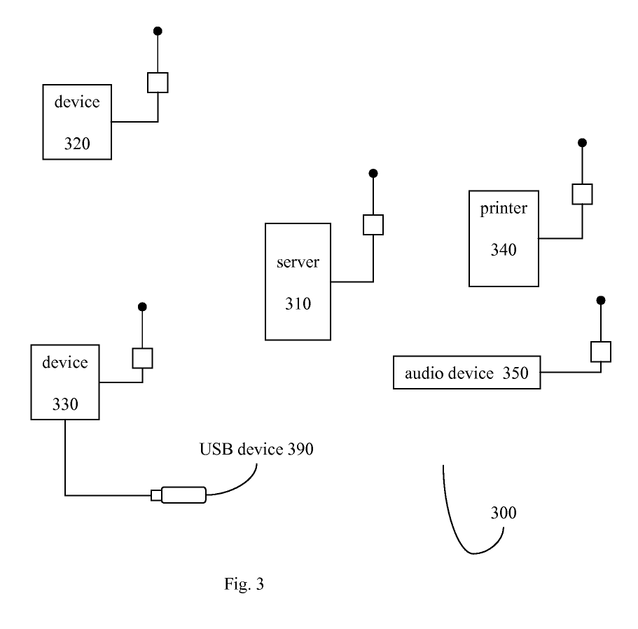

Just as a wired network may need properly provisioned devices, a wireless network may require a provisioned device. FIG. 3 illustrates an embodiment of a wireless network in which a USB provisioning device may be used. Network 300 provides a wireless network in which devices may be provisioned to allow for network communication. Server 310 is illustrated with a wireless antenna attached. Similarly, devices 320 and 330 are illustrated with wireless antennas attached. Likewise, printer 340 and audio device 350 are provided with wireless antennas attached. In this particular instance, USB provisioning device 390 is coupled to device 330 through a wired connection.

USB provisioning device 390 may be used to provision various components for use with network 300, and may either use the wireless network connection available through a device such as device 330, or may use an independent wireless channel if available. Devices 320 and 330, for example, may represent personal devices, personal computers, or other components suitable for use in a network. Audio device 350, for example, may represent a personal music player (e.g. an MP3 player) with network capabilities.

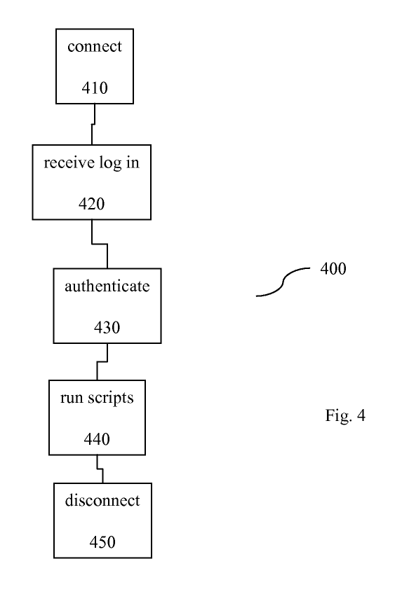

While various processes may be used to provision a device, one may expect that a USB provisioning device will use a process such as the following. FIG. 4 illustrates an embodiment of a process of operating a USB provisioning device. Process 400 includes connecting a provisioning device, receiving a log-in, authenticating the connection, running scripts, and disconnecting. Process 400 and other processes of this document are implemented as a set of modules, which may be process modules or operations, software modules with associated functions or effects, hardware modules designed to fulfill the process operations, or some combination of the various types of modules, for example. The modules of process 400 and other processes described herein may be rearranged, such as in a parallel or serial fashion, and may be reordered, combined, or subdivided in various embodiments.

Process 400 initiates with connection of a USB provisioning device to a component to be provisioned at module 410. At module 420, a log-in occurs, such as through verification that a user has an appropriate password for use with a network, for example. Logging in may or may not be required in all embodiments, and some embodiments may simply check a predetermined location in a memory of the USB provisioning device for identification, for example. At module 430, log-in information or other security information is authenticated, such as through an exchange with a server, for example.

Scripts are then run, to determine what the component to be provisioned is, and to then provision the component at module 440. Such scripts may be a set of scripts or a single script, for example. Moreover, the scripts may be encoded in a variety of different formats, allowing for execution in a variety of different environments. These scripts may be customized to different networks and profiles for variations based on different entities, different types of devices, and different users, for example. Also, these scripts may be encrypted and/or digitally signed for security purposes, for example. With the component provisioned, the provisioning device may be disconnected at module 450. This process may be repeated for various different devices.

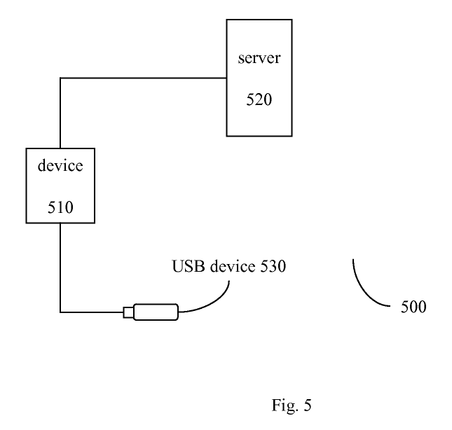

One may further understand such processes based on a simple configuration in which a device may be provisioned. FIG. 5 illustrates an embodiment of a system in which a USB provisioning device is in use. System 500 includes a server, a networked device and a USB provisioning device. Device 510 is coupled to server 520, through a wired connection as illustrated, although a wireless coupling may be used as well. When USB provisioning device 530 is connected to device 510, it can be authenticated through communication with server 520, whether through a log-in or through authentication of a digital certificate, for example.

If an antenna is present in the USB provisioning device 530, it can communicate directly with server 520 for information related to provisioning device 510. Alternatively, provisioning device 530 may communicate using the network connection of device 510. This allows for running of provisioning scripts, requesting network data from server 520 and registering device 510 with server 520, for example. Provisioning device 530 may then be disconnected from device 510 to allow for provisioning of another device, for example. Alternatively, provisioning device 530 may be continuously connected to device 510 in some embodiments, to allow for continuous adaptation to a network, maintenance of the provisioning device 530, or other applications.

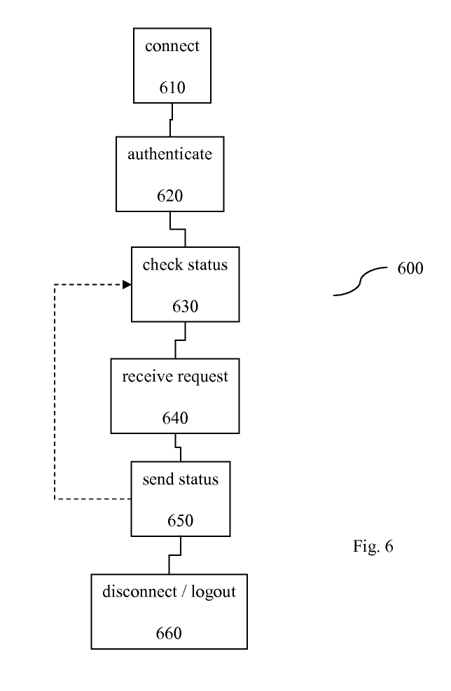

Alternatively, an ongoing process of provisioning and monitoring may be implemented. FIG. 6 illustrates an embodiment of a process of using a USB provisioning device on an ongoing basis. Process 600 includes connecting a provisioning device to a device, authenticating the device, checking status of the device, receiving a request for status of the device, sending status of the device, and disconnecting or logging out of the service. This process may be used in addition to original provisioning of a device, or as a separate process for monitoring a device, for example.

Initially, the provisioning device is connected to a device to be monitored at module 600. This may be accomplished in conjunction with originally provisioning a device such as through process 500, or when a device is to be monitored, such as due to a malfunction. At module 620, the device to be monitored is authenticated—a determination is made as to whether the monitoring device and the device to be monitored can be trusted by a network.

The monitoring or provisioning device checks the status of the device to be monitored at module 630. At module 640, a request is sent via a network connection to provide status on the device monitored. Responsive to this request, status information is sent on the monitored device to the network at module 650. Alternatively, the status information may be requested after or responsive to the request for information at module 640. In either embodiment, the result is a monitored device which can be monitored through an existing network connection or through a wireless connection provided by a provisioning device.

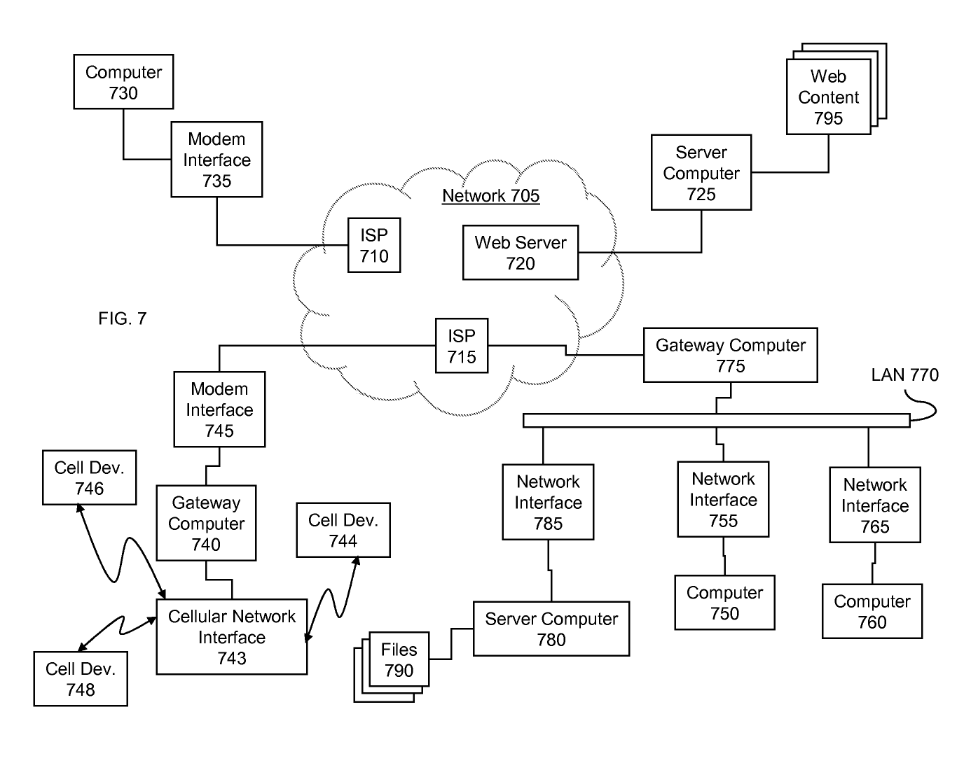

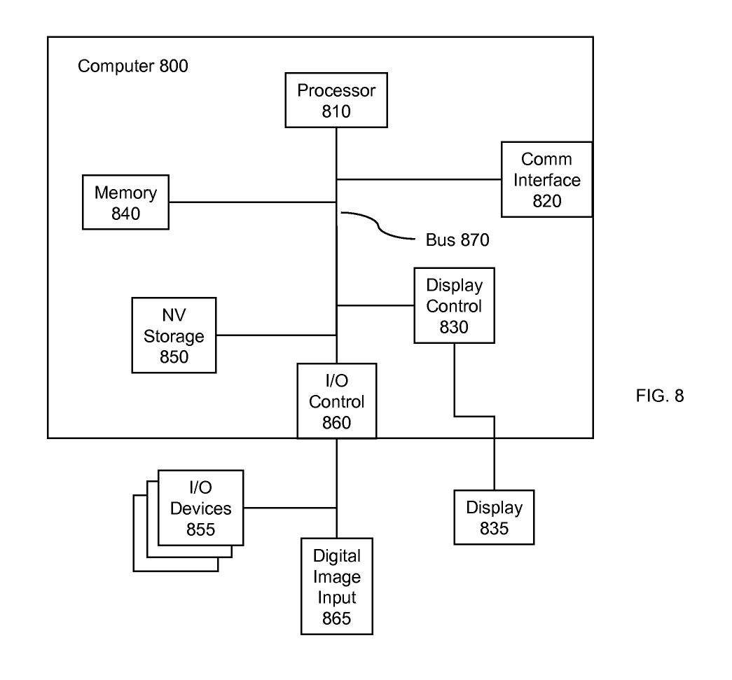

While various methods and systems have been described, one may expect that the types of networks and devices used may vary considerably. FIG. 7 illustrates another embodiment of a network in which a USB provisioning device may be used. FIG. 8 illustrates an embodiment of a device which may be used with a USB provisioning device. The following description of FIGS. 7-8 is intended to provide an overview of device hardware and other operating components suitable for performing the methods of the invention described above and hereafter, but is not intended to limit the applicable environments. Similarly, the hardware and other operating components may be suitable as part of the apparatuses described above. The invention can be practiced with other system configurations, including personal computers, multiprocessor systems, microprocessor-based or programmable consumer electronics, network PCs, minicomputers, mainframe computers, and the like. The invention can also be practiced in distributed computing environments where tasks are performed by remote processing devices that are linked through a communications network.

FIG. 7 shows several computer systems that are coupled together through a network 705, such as the internet, along with a cellular or other wireless network and related cellular or other wireless devices. The term “internet” as used herein refers to a network of networks which uses certain protocols, such as the TCP/IP protocol, and possibly other protocols such as the hypertext transfer protocol (HTTP) for hypertext markup language (HTML) documents that make up the world wide web (web). The physical connections of the internet and the protocols and communication procedures of the internet are well known to those of skill in the art.

Access to the internet 705 is typically provided by internet service providers (ISP), such as the ISPs 710 and 715. Users on client systems, such as client computer systems 730, 750, and 760 obtain access to the internet through the internet service providers, such as ISPs 710 and 715. Access to the internet allows users of the client computer systems to exchange information, receive and send e-mails, and view documents, such as documents which have been prepared in the HTML format. These documents are often provided by web servers, such as web server 720 which is considered to be “on” the internet. Often these web servers are provided by the ISPs, such as ISP 710, although a computer system can be set up and connected to the internet without that system also being an ISP.

The web server 720 is typically at least one computer system which operates as a server computer system and is configured to operate with the protocols of the world wide web and is coupled to the internet. Optionally, the web server 720 can be part of an ISP which provides access to the internet for client systems. The web server 720 is shown coupled to the server computer system 725 which itself is coupled to web content 795, which can be considered a form of a media database. While two computer systems 720 and 725 are shown in FIG. 7, the web server system 720 and the server computer system 725 can be one computer system having different software components providing the web server functionality and the server functionality provided by the server computer system 725 which will be described further below.

Cellular network interface 743 provides an interface between a cellular network and corresponding cellular devices 744, 746 and 748 on one side, and network 705 on the other side. Thus cellular devices 744, 746 and 748, which may be personal devices including cellular telephones, two-way pagers, personal digital assistants or other similar devices, may connect with network 705 and exchange information such as email, content, or HTTP-formatted data, for example.

Cellular network interface 743 is representative of wireless networking in general. In various embodiments, such an interface may also be implemented as a wireless interface such as a Bluetooth interface, IEEE 802.11 interface, or some other form of wireless network. Similarly, devices such as devices 744, 746 and 748 may be implemented to communicate via the Bluetooth or 802.11 protocols, for example. Other dedicated wireless networks may also be implemented in a similar fashion.

Cellular network interface 743 is coupled to computer 740, which communicates with network 705 through modem interface 745. Computer 740 may be a personal computer, server computer or the like, and serves as a gateway. Thus, computer 740 may be similar to client computers 750 and 760 or to gateway computer 775, for example. Software or content may then be uploaded or downloaded through the connection provided by interface 743, computer 740 and modem 745.

Client computer systems 730, 750, and 760 can each, with the appropriate web browsing software, view HTML pages provided by the web server 720. The ISP 710 provides internet connectivity to the client computer system 730 through the modem interface 735 which can be considered part of the client computer system 730. The client computer system can be a personal computer system, a network computer, a web tv system, or other such computer system.

Similarly, the ISP 715 provides internet connectivity for client systems 750 and 760, although as shown in FIG. 7, the connections are not the same as for more directly connected computer systems. Client computer systems 750 and 760 are part of a LAN coupled through a gateway computer 775. While FIG. 7 shows the interfaces 735 and 745 as generically as a “modem,” each of these interfaces can be an analog modem, isdn modem, cable modem, satellite transmission interface (e.g. “direct PC”), or other interfaces for coupling a computer system to other computer systems.

Client computer systems 750 and 760 are coupled to a LAN 770 through network interfaces 755 and 765, which can be ethernet network or other network interfaces. The LAN 770 is also coupled to a gateway computer system 775 which can provide firewall and other internet related services for the local area network. This gateway computer system 775 is coupled to the ISP 715 to provide internet connectivity to the client computer systems 750 and 760. The gateway computer system 775 can be a conventional server computer system. Also, the web server system 720 can be a conventional server computer system.

Alternatively, a server computer system 780 can be directly coupled to the LAN 770 through a network interface 785 to provide files 790 and other services to the clients 750, 760, without the need to connect to the internet through the gateway system 775.

FIG. 8 shows one example of a personal device that can be used as a cellular telephone (744, 746 or 748) or similar personal device, or may be used as a more conventional personal computer, as an embedded processor or local console, or as a PDA, for example. Such a device can be used to perform many functions depending on implementation, such as monitoring functions, user interface functions, telephone communications, two-way pager communications, personal organizing, or similar functions. The system 800 of FIG. 8 may also be used to implement other devices such as a personal computer, network computer, or other similar systems. The computer system 800 interfaces to external systems through the communications interface 820. In a cellular telephone, this interface is typically a radio interface for communication with a cellular network, and may also include some form of cabled interface for use with an immediately available personal computer. In a two-way pager, the communications interface 820 is typically a radio interface for communication with a data transmission network, but may similarly include a cabled or cradled interface as well. In a personal digital assistant, communications interface 820 typically includes a cradled or cabled interface, and may also include some form of radio interface such as a Bluetooth or 802.11 interface, or a cellular radio interface for example.

The computer system 800 includes a processor 810, which can be a conventional microprocessor such as an Intel pentium microprocessor or Motorola power PC microprocessor, a Texas Instruments digital signal processor, or some combination of the various types or processors. Memory 840 is coupled to the processor 810 by a bus 870. Memory 840 can be dynamic random access memory (dram) and can also include static ram (sram), or may include FLASH EEPROM, too. The bus 870 couples the processor 810 to the memory 840, also to non-volatile storage 850, to display controller 830, and to the input/output (I/O) controller 860. Note that the display controller 830 and I/O controller 860 may be integrated together, and the display may also provide input.

The display controller 830 controls in the conventional manner a display on a display device 835 which typically is a liquid crystal display (LCD) or similar flat-panel, small form factor display. The input/output devices 855 can include a keyboard, or stylus and touch-screen, and may sometimes be extended to include disk drives, printers, a scanner, and other input and output devices, including a mouse or other pointing device. The display controller 830 and the I/O controller 860 can be implemented with conventional well known technology. A digital image input device 865 can be a digital camera which is coupled to an I/O controller 860 in order to allow images from the digital camera to be input into the device 800.

The non-volatile storage 850 is often a FLASH memory or read-only memory, or some combination of the two. A magnetic hard disk, an optical disk, or another form of storage for large amounts of data may also be used in some embodiments, though the form factors for such devices typically preclude installation as a permanent component of the device 800. Rather, a mass storage device on another computer is typically used in conjunction with the more limited storage of the device 800. Some of this data is often written, by a direct memory access process, into memory 840 during execution of software in the device 800. One of skill in the art will immediately recognize that the terms “machine-readable medium” or “computer-readable medium” includes any type of storage device that is accessible by the processor 810 and also encompasses a carrier wave that encodes a data signal.

The device 800 is one example of many possible devices which have different architectures. For example, devices based on an Intel microprocessor often have multiple buses, one of which can be an input/output (I/O) bus for the peripherals and one that directly connects the processor 810 and the memory 840 (often referred to as a memory bus). The buses are connected together through bridge components that perform any necessary translation due to differing bus protocols.

In addition, the device 800 is controlled by operating system software which includes a file management system, such as a disk operating system, which is part of the operating system software. One example of an operating system software with its associated file management system software is the family of operating systems known as Windows CE® and Windows® from Microsoft Corporation of Redmond, Wash., and their associated file management systems. Another example of an operating system software with its associated file management system software is the Palm® operating system and its associated file management system. The file management system is typically stored in the non-volatile storage 850 and causes the processor 810 to execute the various acts required by the operating system to input and output data and to store data in memory, including storing files on the non-volatile storage 850. Other operating systems may be provided by makers of devices, and those operating systems typically will have device-specific features which are not part of similar operating systems on similar devices. Similarly, WinCE® or Palm® operating systems may be adapted to specific devices for specific device capabilities.

Device 800 may be integrated onto a single chip or set of chips in some embodiments, and typically is fitted into a small form factor for use as a personal device. Thus, it is not uncommon for a processor, bus, onboard memory, and display/I-O controllers to all be integrated onto a single chip. Alternatively, functions may be split into several chips with point-to-point interconnection, causing the bus to be logically apparent but not physically obvious from inspection of either the actual device or related schematics.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention, in some embodiments, also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language, and various embodiments may thus be implemented using a variety of programming languages.

One skilled in the art will appreciate that although specific examples and embodiments of the system and methods have been described for purposes of illustration, various modifications can be made without deviating from the present invention. For example, embodiments of the present invention may be applied to many different types of databases, systems and application programs. Moreover, features of one embodiment may be incorporated into other embodiments, even where those features are not described together in a single embodiment within the present document.

1. (canceled)

2. A method, comprising:
receiving control of a new device coupled to a USB provisioning device;
connecting the USB provisioning device through a network connection to a server;
the USB provisioning device automatically provisioning the new device responsive to information related to the device and information related to the server; and
relinquishing control of the new device.

3. The method of claim 3, wherein:
the USB provisioning device includes an instant messaging client which connects to the server.

4. The method of claim 3, wherein:
the USB provisioning device connects to the server through a network connection of the new device.

5. The method of claim 3, wherein:
the USB provisioning device connects to the server through a network interface of the USB provisioning device.

6. The method of claim 5, wherein:
the network interface of the USB provisioning device is a Bluetooth interface.

7. The method of claim 5, wherein:
the network interface of the USB provisioning device is an 802.11 interface.

8. The method of claim 2, wherein:
automatically provisioning the new device includes running a provisioning script responsive to information related to the device.

9. The method of claim 2, wherein:
automatically provisioning the new device configures the device to communicate with a network coupled to the server.

10. The method of claim 2, wherein:
automatically provisioning the new device configures the device to use a predetermined device configuration.

11. The method of claim 2, further comprising:
authenticating the USB provisioning device.

12. The method of claim 11, further comprising:
receiving a login at the USB provisioning device.

13. A USB provisioning device, comprising:
an instant messaging client;
a provisioning script; and
an identifier of the USB provisioning device.

14. The USB provisioning device of claim 13, further comprising:
means for communicating wirelessly with a network.

15. The USB provisioning device of claim 14, wherein:
the means for communicating wirelessly with a network comprises a wireless communication device.

16. The USB provisioning device of claim 13, further comprising:
a set of network codes related to one or more networks.

17. A machine-readable medium embodied in a USB provisioning device, the machine-readable medium embodying instructions, the instructions, when executed by a processor coupled to the machine-readable medium, causing the processor to perform a method, the method comprising:
receiving control of a new device coupled to the USB provisioning device;
connecting the USB provisioning device through a network connection to a server;
the USB provisioning device automatically provisioning the new device responsive to information related to the device and information related to the server; and
relinquishing control of the new device.

18. The machine-readable medium of claim 17, wherein the method further comprises:
authenticating the USB provisioning device.

19. The machine-readable medium of claim 18, wherein the method further comprises:
receiving a login at the USB provisioning device.

20. The machine-readable medium of claim 17, wherein:
automatically provisioning the new device includes running a provisioning script responsive to information related to the device.

21. The machine-readable medium of claim 17, wherein:
automatically provisioning the new device configures the device to communicate with a network coupled to the server.

22. The machine-readable medium of claim 17, wherein:
automatically provisioning the new device configures the device to use a predetermined device configuration.
